(19) United States
(12) Patent Application Publication
(10) Pub. No.: US 2006/0066389 A1
(43) Pub. Date: Mar. 30, 2006

(54) Variable gain charge pump controller

(76) Inventor: Gregory William Wardle, Milpitas, CA (US)

Correspondence Address: ADVANCED ANALOGIC TECHNOLOGIES, 830 EAST ARQUES AVE, SUNNYVALE, CA, 94085, US

(21) Appl. No.: 10/955,755

(22) Filed: Sep. 29, 2004

(51) Int. Cl. G05F 1/10; G05F 3/02

(52) U.S. Cl. 327/536

(57) ABSTRACT

A variable gain charge pump controller includes a switching network connected to three external capacitors: a first input capacitor, a second input capacitor and an output capacitor. Two of these capacitors (the first input capacitor and the output capacitor) are connected between the controller and ground. Both terminals of the second input capacitor are also connected to the controller bringing the total number of pins required (with pins for power and ground) to six. The first input capacitor is continuously charged with a voltage αV_{AMP}, which can be a function of the input voltage or the output voltage. The controller operates in an alternating sequence that includes a phase where the input capacitors are connected in series between the ground voltage and the output node, and a phase where the second input capacitor is connected between the ground voltage and the input voltage.

### BACKGROUND OF THE INVENTION

Charge pumps are commonly used to boost battery output in portable electronic systems. As shown in FIG. 1, a typical charge pump includes a network of capacitors and switches. The switches are used to operate the charge pump in a repeating two phase sequence. During the first phase (drawn with solid lines), two capacitors, C₁ and C₂, called “flying capacitors” are connected in series between a voltage source and ground. This causes each capacitor to be charged to a value of V_{cc}/2 (assuming that both capacitors are initially discharged and neglecting voltage drops across the switches). During the second phase (drawn with dashed lines), capacitors C₁ and C₂ are connected in parallel with each other and in series with the voltage source and a third capacitor C₃. This connection provides a voltage of 1.5 times V_{cc} to drive the load and is the reason that the charge pump of FIG. 1 is commonly referred to as a 1.5× charge pump.

Commercially available charge pumps are typically implemented as charge pump controllers (i.e., small integrated circuits) that are connected to external discrete capacitors. As an example, FIG. 2 shows a 1.5× charge pump implemented as a charge pump controller 202 connected to external capacitors 204a and 204b. The controller 202 includes a switching network that supports interconnection of the external capacitors 204 in the two configurations shown in FIG. 1. The switching network is connected to the external capacitors 204 using I/O pins, two of which (206a and 206b) are specifically labeled. The number of I/O pins is generally determined by the charge pump type. For 1.5× charge pumps seven such pins are necessary. These include power, ground and output as well as one I/O pin for each terminal of each flying capacitor. Other charge pump types may be constructed using fewer I/O pins. This is true, for example of the 2× charge pump shown in FIG. 3 which doubles the input voltage and requires five I/O pins.

In practice, reducing I/O pin count is often an important consideration. This is especially true for standalone devices such as charge pump controllers and other power management functions. Devices of this type are often implemented using small packages which, by nature include a very limited number of I/O pins. As a result, eliminating even a single pin (from the total required to perform a given function) can be a major advantage. For this reason, it is easy to appreciate the desirability of alternative charge pump designs that can be implemented with fewer I/O pins.

### SUMMARY OF THE INVENTION

The present invention provides a variable gain charge pump controller with a reduced number of I/O pins. For typical applications, the charge pump controller is connected to three external capacitors (first and second input capacitors and an output capacitor). Of these, only the second input capacitor is a flying capacitor requiring two pins. The other two capacitors are wired to ground and are connected to the controller using one terminal each. Pins for the input voltage and ground voltage bring the total required number of I/O pins to six.

The controller includes an amplifier or other device that generates a voltage V_{AMP}. V_{AMP} is an implementation dependent quantity that determines the nature of the charge pump associated with the controller. To implement a fractional charge pump, for example V_{AMP} may be selected as V_{AMP}=αV_{IN} where α is some constant between zero and one. The voltage V_{AMP} continuously charges the first input capacitor.

A switching network within the controller is used to control the operation of the capacitors in a two-phase sequence. In the first phase, the second input capacitor is connected between the input voltage V_{IN} and the ground voltage. This charges the second input capacitor to V_{IN}. The first input capacitor voltage is fixed at V_{AMP}. In the second phase, the two input capacitors are connected in series with the output capacitor. This charges the output capacitor to the combined potential of the two input capacitors (i.e., (1+α) V_{IN} if V_{AMP}=αV_{IN} as in the example above). As the first phase repeats, the series connection between the two input capacitors and the output capacitor is broken as the second input capacitor is reconnected to V_{IN} and the ground voltage. This allows the output capacitor to discharge across a load, such as an LED.

It is also possible to configure the charge pump controller to operate in a feedback configuration. This type of configuration is particularly useful where the charge pump is driving a device, such as a current source that has a varying voltage requirement. V_{AMP} can then be selected as a function of the voltage required by the driven device. This allows the charge pump to adaptively react while minimizing excess headroom (excess headroom may waste power and reduce overall efficiency).

Compared to traditional 1.5× charge pump controllers, the variable gain charge pump controller of the current invention uses one less I/O pin. The output voltage is also variable from V_{IN} to 2V_{IN}. This allows the controller to support both 1.5 and 2× operation with minimal I/O pin use.

### BRIEF DESCRIPTION OF THE DRAWINGS

FIG. 1 is a block diagram of a prior art 1.5× charge pump.

FIG. 2 is a block diagram of a prior art 1.5× charge pump.

FIG. 3 is a block diagram of a prior art 2.0× charge pump.

FIG. 4 is a block diagram of a variable gain charge pump as provided by an embodiment of the present invention.

FIG. 5A is a block diagram of the variable gain charge pump of FIG. 4 during a first phase of operation.

FIG. 5B is a block diagram of the variable gain charge pump of FIG. 4 during a second phase of operation.

FIG. 6A is a block diagram of the variable gain charge pump of FIG. 4 operating in a feedback configuration during a first phase of operation.

FIG. 6B is a block diagram of the variable gain charge pump of FIG. 4 operating in a feedback configuration during a second phase of operation.

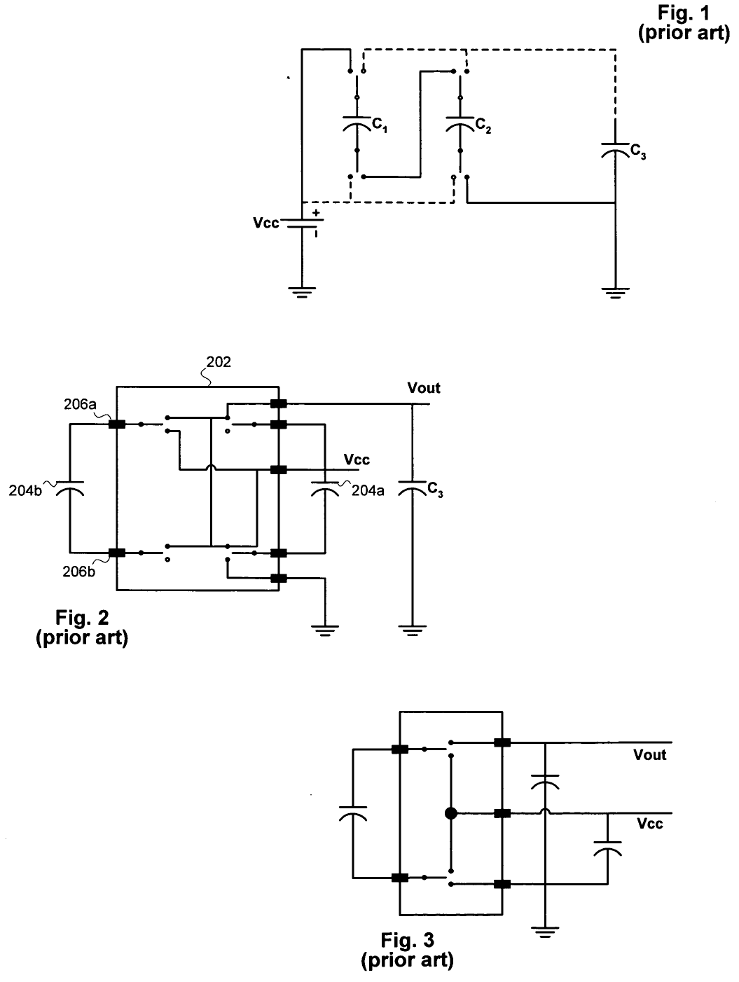

### DETAILED DESCRIPTION OF THE PREFERRED EMBODIMENTS

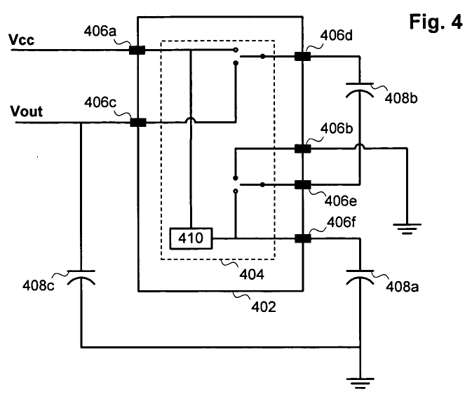

The present invention provides a variable gain charge pump controller with a reduced number of I/O pins. As shown in FIG. 4, a typical implementation includes a package 402 that surrounds a switching network 404. Package 402 is representative of the packages normally used in the semiconductor industry to enclose integrated circuits. Switching network 404 is connected to a series of I/O pins or leads 406. These should be considered to be representative of the wide array of interconnection technologies that are used to connect integrated circuits to other components.

I/O pins 406a and 406b are used to provide an input voltage (V_{IN}) and a ground voltage to the charge pump controller. I/O pins 406c through 406f connect three external capacitors to switching network 404. The capacitors are first input capacitor 408a, second input capacitor 408b and output capacitor 408c. The first input capacitor 408a and the output capacitor 408c are connected between the switching network and ground using a single I/O pin each (406f and 406c). The second input capacitor 408b is connected to switching network 404 using I/O pins 406d and 406e.

Switching network 404 includes an amplifier 410 for generating a voltage V_{AMP} typically a scaled version of V_{IN}(e.g., V_{IN}=αV_{IN}). The constant α determines the “gain” of the variable gain charge pump. If αV_{IN} is ½ V_{IN} then the variable gain charge pump operates as a 1.5×charge pump. If αV_{IN} is V_{IN} then the variable gain charge pump operates as a 2× charge pump. In general, amplifier 410 is an op amp or other mechanism that allows V_{AMP} to be dynamically controlled or selected.

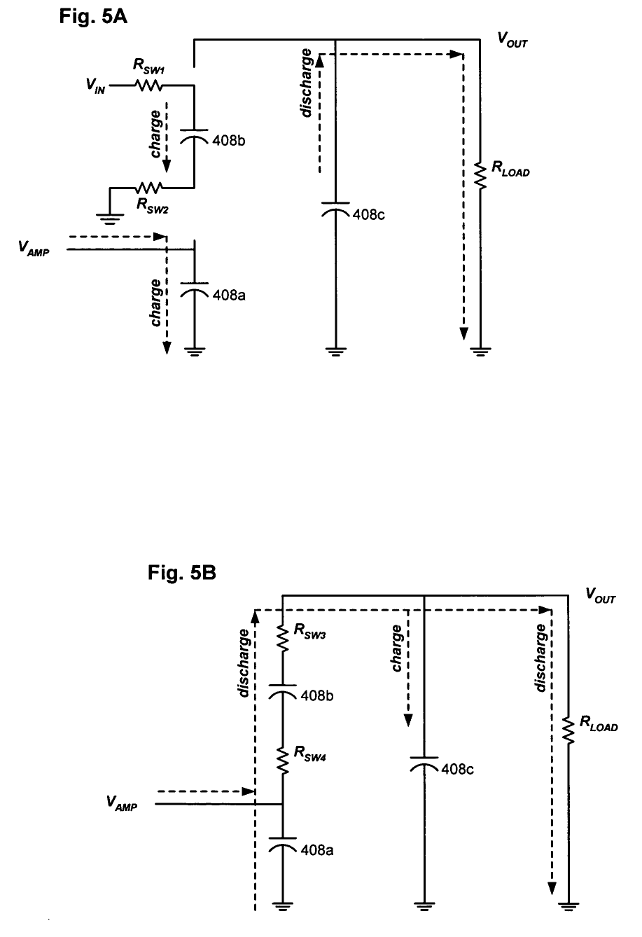

Switching network 404 is used to control the operation of capacitors 408 in a two-phase sequence. As shown in FIGS. 5A and 5B, the first input capacitor 408a is connected between V_{AMP} and ground. As a result, first input capacitor 408a is constantly charged to V_{AMP} during both phases.

In the first phase (FIG. 5A), there is no connection between first input capacitor 408a, second input capacitor 408b and output capacitor 408c. The second input capacitor 408b is connected between V_{IN} and ground. This charges the second input capacitor to V_{IN}.

In the second phase, the two input capacitors (408a and 408b) are connected in series with the output capacitor 408c. This charges the output capacitor 408c to the combined potential of the two input capacitors (408a and 408b). As the first phase repeats, the series connection between the two input capacitors (408a and 408b) and the output capacitor 408c is broken as the first input capacitor 408a is reconnected between V_{AMP} and ground. This allows the output capacitor 408c to discharge across a load, such as an LED. Note that in FIGS. 5A and 5B (as well as in subsequent Figures) R_{sw1}, R_{sw2}, R_{sw3} and R_{sw4} represent switch resistances.

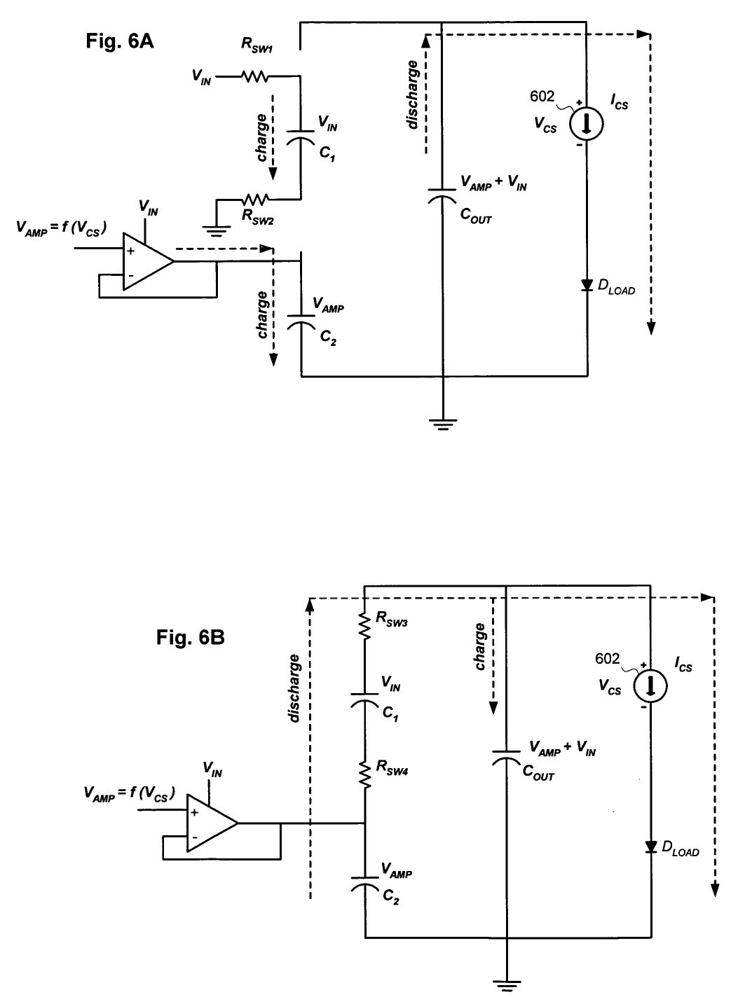

As shown in FIGS. 6A and 6B, it is also possible to configure the charge pump controller to operate in a feedback configuration. This type of configuration is particularly useful where the charge pump is driving a device, such as current source 602 that has a varying voltage requirement. To maximize efficiency, it is desirable to match the output of the charge pump with the voltage (V_{cs}) required by current source 602. This is accomplished by making V_{AMP} a function of V_{cs}. This allows the charge pump to adaptively react while minimizing excess headroom. Note that in FIGS. 5A to 6B, Rsw1, Rsw2, Rsw3 and Rsw4 represent switch resistances.

As shown in FIG. 4, the variable gain charge pump uses a total of six I/O pins (406a through 406f). This is one less than required for traditional 1.5× charge pump designs. The output voltage is also variable from V_{IN} to 2V_{IN}. This allows the charge pump to support both 1.5 and 2× operation with minimal I/O pin use.

What is claimed is:

1. A charge pump for increasing an input voltage, the charge pump comprising:
an output capacitor connected between a ground voltage and an output node;
a first input capacitor connected between the ground voltage and a voltage V_{AMP};
a second input capacitor;
a switching network configured to control operation of the capacitors in an alternating sequence that includes:
a first phase where the second input capacitor is connected between the ground voltage and the input voltage; and
a second phase where the input capacitors are connected in series between the ground voltage and the output node.

2. A charge pump as recited in claim 1 in which the voltage V_{AMP} is a fraction of the input voltage.

3. A charge pump as recited in claim 1 in which the voltage V_{AMP} is an adaptive function of the voltage required by a device driven by the charge pump.

4. A charge pump controller for increasing an input voltage, the charge pump controller comprising:
a switching network configured to be connected to an output capacitor, a first input capacitor and a second input capacitor using no more than four I/O pins;
the switching network configured so that the output capacitor is connected between a ground voltage and an output node;
the first input capacitor is connected between the ground voltage and a voltage V_{AMP};
with the switching network configured to control operation of the capacitors in an alternating sequence that includes:
a first phase where the second input capacitor is connected between the ground voltage and the input voltage; and
a second phase where the input capacitors are connected in series between the ground voltage and the output node.

5. A charge pump controller as recited in claim 4 in which the voltage V_{AMP} is a fraction of the input voltage.

6. A charge pump controller as recited in claim 4 in which the voltage V_{AMP} is an adaptive function of the voltage required by a device driven by the charge pump controller.

7. A charge pump controller that comprises:
a switching network;
a first I/O pin configured allow an output capacitor to be connected between a ground voltage and an output node of the switching network;
a second I/O pin configured to allow a first input capacitor to be connected between the ground voltage and a voltage V_{AMP};
third and fourth I/O pins allowing the anode and cathode of a second input capacitor to be connected to the switching network
where the switching network is configured to control operation of the capacitors in an alternating sequence that includes:
a first phase where the second input capacitor is connected between the ground voltage and the input voltage; and
a second phase where the input capacitors are connected in series between the ground voltage and the output node.

7. A charge pump controller as recited in claim 6 in which the voltage V_{AMP} is a fraction of the input voltage.

8. A charge pump controller as recited in claim 6 in which the voltage V_{AMP} is an adaptive function of the voltage required by a device driven by the charge pump controller.

9. A method for increasing an input voltage to an output voltage, the method comprising:
connecting an output capacitor between a ground voltage and an output node;
connecting a first input capacitor between the ground voltage and a voltage V_{AMP};
operating a switching network in an alternating sequence that includes:
a first phase where the second input capacitor is connected between the ground voltage and the input voltage; and
a second phase where the first input capacitor and a second input capacitor are connected in series between the ground voltage and the output node.

10. A method as recited in claim 9 in which the voltage V_{AMP} is a fraction of the input voltage.

11. A method as recited in claim 9 in which the voltage V_{AMP} is an adaptive function of the voltage required by a device driven by the output voltage.
